(19) United States
(12) Patent Application Publication
(10) Pub. No.: US 2016/0033920 A1
(43) Pub. Date: Feb. 4, 2016

(54) SURFACE PROCESSOR AND ELECTROPHOTOGRAPHIC APPARATUS

(71) Applicants: Masahide YAMASHITA, Tokyo (JP); Koichi KATO, Kanagawa (JP); Mayumi YOSHIHARA, Kanagawa (JP); Sayaka KATOH, Tokyo (JP)

(72) Inventors: Masahide YAMASHITA, Tokyo (JP); Koichi KATO, Kanagawa (JP); Mayumi YOSHIHARA, Kanagawa (JP); Sayaka KATOH, Tokyo (JP)

(21) Appl. No.: 14/797,356

(22) Filed: Jul. 13, 2015

(30) Foreign Application Priority Data
Aug. 4, 2014 (JP) 2014-158981

(51) Int. Cl. G03G 15/00

(52) U.S. Cl. CPC G03G 15/6582

(57) ABSTRACT

A surface processor processing the surface of a recording medium before a toner image is formed thereon includes a surface reformer to reform the surface of the recording medium a toner image is formed on; and an applicator to apply the surface of the recording medium after reformed with a toner affinity ingredient.

### CROSS-REFERENCE TO RELATED APPLICATIONS

This patent application is based on and claims priority pursuant to 35 U.S.C. §119 to Japanese Patent Application No. 2014-158981, filed on Aug. 4, 2014, in the Japan Patent Office, the entire disclosure of which is hereby incorporated by reference herein.

### BACKGROUND

1. Technical Field

The present invention relates to a surface processor processing the surface of a recording medium before a toner image is transferred onto, and an electrophotographic apparatus using the surface processor.

2. Description of the Related Art

In an electrophotographic system, an electrostatic latent image is initially formed on a uniformly charged photoreceptor as a latent image bearer. The electrostatic latent image is subsequently visualized with a toner to form a toner image in a development process. The toner image is subsequently transferred onto a recording medium such as a recording paper, and is subsequently fixed thereon to obtain an output image. As devices to execute the above-described series of processes, a latent image former including a charger and a latent image writer, an image developer, a transferer, and a fixer are typically used, respectively.

As the charger, either a non-contact charger or a contact charger may be employed. As the non-contact charger, a corona discharge is well known. As the contact charger, there is a system that employs a proximity charger to place the charger near the latent image bearer with a given amount of clearance. Also known as a contact charging system is a system that brings a charger, such as a charging brush, a charging roller, etc., in contact with a latent image bearer.

The image developer utilizes one-component developer or two-component developer. As the one-component developer, only developer such as magnetic toner, etc., capable of standing the particles up on end by itself is used, for example. As the two-component developer, toner particles and carriers, such as iron filings, etc., capable of raising the spike while bearing the toner particles on the carriers are used.

In a conventional copier, printer, or multifunctional machine, since high-speed performance, high image reproducibility, long-term stability of image quality, quick startup performance, stability of electrostatic charging of toner, etc., are required, a two-component developing unit using the two-component developer is frequently adopted. By contrast, in a compact printer or facsimile machine expected to save cost and space or the like, a one-component developing unit with the one-component developer is frequently adopted.

Recently, electrophotographic image forming apparatuses have been mostly used even in commercial printing fields. Particularly, as for printing in a small quantity or individual printings having different printing data, offset printings needing printing plates cost too high to comply with these printings. Therefore, electrophotographic on-demand printing capable of transforming printed images into electronic data is effectively used. In the commercial printing fields, not only typical papers for copiers used in offices, but also recording media having various thicknesses and material properties are used. Plastic media such as recording media formed of plastic materials having very high smoothness and glossiness or on the contrary, recording media having specific concavities and convexities to exert visual special effects are widely used in wrapping material applications and decoration applications.

However, the electrophotographic image forming method has not fully complied with the plastic media. Particularly, disturbed images in the transfer process electrostatically transferring a toner onto a recording medium and insufficient adhesiveness between a toner and a recording medium in the fixing process melting and fixing a toner on a recording medium with heat and pressure mostly are fatal for the commercial printings.

The market demands for forming images at cost as low as possible even on recording media besides papers. In the commercial printing market, there is a strong demand for stably forming images even on recording media having various surface properties at low cost.

An image forming apparatus in the commercial printing fields needs forming high-quality images on various recording media with good fixability. Therefore, a toner image formed in the image forming apparatus needs transferring onto a recording medium and the toner image thereon needs adhering to and fixing on the recording medium.

### SUMMARY

Accordingly, one object of the present invention is to provide a surface processor for recording media used in electrophotographic methods, which is capable of stably preventing images from disturbing and a toner from releasing when images are scratched.

Another object of the present invention is to provide an image forming apparatus capable of forming images on various recording media.

These objects and other objects of the present invention, either individually or collectively, have been satisfied by the discovery of a surface processor processing the surface of a recording medium before a toner image is formed thereon, including a surface reformer to reform the surface of the recording medium a toner image is formed on; and an applicator to apply the surface of the recording medium after reformed with a toner affinity ingredient.

In another aspect of the present invention, an image forming including the surface professor, and further a memory too memorize properties of the recording medium; a selector to select the recording medium; and a setter to set conditions of the surface processor for processing the surface of the recoding medium.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic view illustrating an embodiment of the surface processor of the present invention;

FIG. 2 is a schematic view illustrating an embodiment 1 of the image forming apparatus of the present invention;

FIG. 3 is an amplified partial view illustrating a layer structure of a photoreceptor which is a latent image bearer; and

FIG. 4 is a schematic view illustrating an embodiment 2 of the image forming apparatus of the present invention.

### DETAILED DESCRIPTION

The present invention provides a surface processor for recording media used in electrophotographic methods, which is capable of stably preventing images from disturbing and a toner from releasing when images are scratched.

Particularly, the present invention relates to a surface processor processing the surface of a recording medium before a toner image is formed thereon, including a surface reformer to the reform the surface of the recording medium a toner image is formed on; and an applicator to apply the surface of the recording medium after reformed with a toner affinity ingredient.

Exemplary embodiments of the present invention are described in detail below with reference to accompanying drawings. In describing exemplary embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

### Embodiment 1

In the image forming apparatus of the present invention, the surface of a recording medium includes an ingredient to control electrical resistance to prevent a toner image from disturbing in the transfer process. In addition, a toner affinity ingredient is present between the recording medium and the toner to improve adhesiveness thereof to the recording medium. Further, the surface of a recording medium is previously activated and various ingredients are applied thereto so as not to release therefrom. The recording medium is processed in stages to have properties suitable for electrophotographic image forming process, and the final image formed thereon has stable quality.

A recording medium having the disturbed images in the transfer process and the insufficient adhesiveness with a toner in the fixing process includes materials having low affinity with other materials and high electrical resistance such as polyethylene and polypropylene in its surface. Therefore, when it is used in an electrophotographic image forming apparatus as it is, an electric field for toner transfer is so large that a slight discharge generates between an image bearer and a recording medium in the apparatus when transferring a toner, resulting in disturbed toner image, i.e., toner scattering and honeycomb-shaped image disturbance. At the same time, since the recording medium has low surface energy, adhesiveness between a melted toner and the recording medium is low even though the toner melts to adhere thereto. Therefore, even though an image appears to be fixed, the toner easily releases from the recording medium with a slight force. Particularly, plastic media having no anchor effect of a melted toner permeating into the recording medium to increase adhesiveness noticeably have the problem.

Soon after the surface of the plastic medium is subjected to a discharge treatment by a method similar to Japanese published unexamined application No. JP-2005-181882-A, when an image is produced by an electrophotographic image forming apparatus, the fixability is slightly improved although a toner image is disturbed as a toner image produced without the discharge treatment. However, compared with a toner image formed on paper media subjected to a discharge treatment, a toner image formed on the plastic media is obviously vulnerable to friction and the toner releases therefrom. After the surface of the plastic medium is subjected to a discharge treatment, the longer a time until an image is formed thereon, the less the improvement effect of fixability. In several hours after the treatment, the effect is lost.

On the other hand, after the surface of the plastic medium is coated with a toner affinity ingredient and dried, when a toner image is formed thereon by an electrophotographic image forming apparatus, the toner image is disturbed less a bit than a toner image formed on an untreated plastic medium. However, the fixability is not improved because adhesiveness between the toner affinity ingredient and the surface of the plastic medium is insufficient. The effect of the toner affinity ingredient continues regardless of the time after it is coated.

The improvement of fixability of a toner on the recording medium such as a plastic medium the melted toner does not permeate into with only the discharge treatment on the surface thereof and coating of the toner affinity ingredient thereon is limited.

Next, after the surface discharge treatment and the toner affinity ingredient coating are made on the same plastic medium, when an image is formed by an electrophotographic image forming apparatus, disturbed toner mages are produced slightly less thereon than on an untreated plastic medium. However, the fixability of the toner images thereon largely improves. It can be guessed this is because the toner affinity ingredient firmly adheres to the surface of the plastic medium previously activated by the discharge treatment and the melted toner is bonded with the toner affinity ingredient. This effect deteriorates as time passes after the discharge treatment as an image is produced with only the discharge treatment as mentioned above. This proves that an electrophotographic image can be formed on a low-cost plastic medium for printing. This decreases cost of commercial printing, and provides stable quality images at low cost.

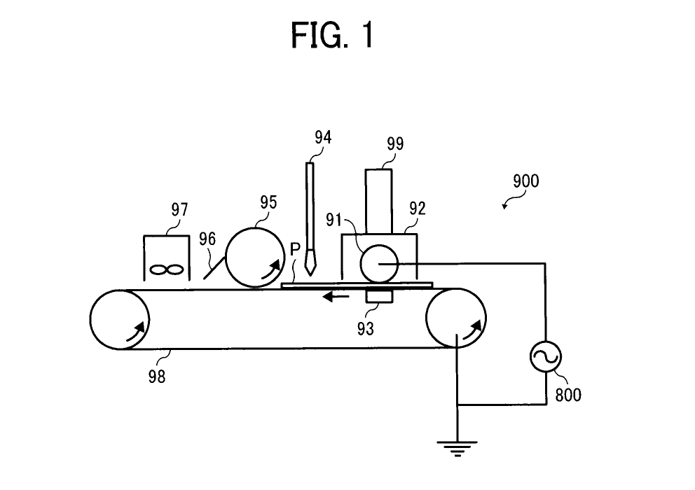

FIG. 1 is a schematic view illustrating an embodiment of the surface processor of the present invention.

A surface processor 900 processes the surface of a recording medium used in an electrophotographic image forming apparatus 100 to be suitable therefor. Specifically, the processor includes a conveyor 98 conveying a recording medium, a surface reformer 92, and an applicator 94 applying a toner affinity ingredient on the surface of the recording medium after reformed. The conveyor 98 includes known means such as conveyance rollers and belts.

The surface reformer 92 is not limited, provided it generates a chemical active species on the surface of the recording medium. Specific examples thereof include scorotron chargers, dischargers applying a high voltage to metallic rollers, etc. to directly or indirectly charging the surface of the recording medium, plasma flow means, exima lamp irradiators, etc. Particularly, the dischargers and the exima lamps are preferably used because they subject oxygen in the atmosphere to decomposition activation to generate ozone capable of activating the surface of the recording medium in a short time with its strong oxidizability. As for the surplus ozone, it is preferable to dispose an ozone removal means in the surface reforming means neighborhood because the ozone adversely affect the neighboring environment and human body.

The applicator 94 is not limited, provided it stably applies the toner affinity ingredient in a constant amount to the surface of the recording medium activated by the surface reforming means mentioned above beforehand. Specific examples thereof include binary fluid sprayers, regular turn roll coaters, reverse turn roll coaters, wire bar coaters, blade coaters, squeeze coaters, sponge rollers, brush rollers, a nonwoven fabrics, etc.

The applicator 94 preferably applies the toner affinity ingredient in the form of a solution or a dispersion to stabilize and uniform the adherence quantity thereof. When the toner affinity ingredient is applied in the form of a solution or a dispersion, a drier 97 is preferably disposed to remove a solvent or a dispersant. The drier includes heater, blowers, depressurizers, etc., which are selected according to conditions such as application speed.

The toner affinity ingredient is the ingredient having high adhesiveness with a toner used in electrophotographic image forming apparatuses, and preferably includes similar materials of the toner constituents. For example, when a toner includes a polyester-based resin as a resin for toners, it is preferable to use carboxylic acid and compositions including an alcoholic hydroxyl group such as polyethylene glycol, copolymers including an acrylic acid, copolymers including methacrylate, compound groups represented by polyol such as polyvinyl alcohol or their copolymers and/or mixtures, but are not limited thereto.

In addition, it is preferable to use a resistance adjustment ingredient mixing with the toner affinity ingredient together to improve transferability of the toner. Specific examples thereof include organic conductive materials represented by quaternary ammonium salts and inorganic conductive particulate materials represented by ITO. It is necessary to limit consumption of the inorganic conductive materials when chosen because of including a lot of colored materials.

The image forming apparatus 100 includes electrophotographic printers, facsimiles, copiers, plotters and their combination machines.

The recording medium is a medium such as papers, threads, fibers, hides, plastics, glasses, woods and ceramics. Plastic media as the recording medium are explained.

Image formation includes giving images such as letters, figures and patterns to a recording medium, visualizing an electrostatic latent image with a colored or non-colored powders (e.g., a toner), and transferring the visible image onto a recording medium and fixing it thereon through an intermediate transfer medium when necessary.

The colored or non-colored powders include single resin powders, compound powders, single or plural color materials, compounds of resins and color materials, and powders including wax ingredients and inorganic materials added thereto. In addition to functional powders the forms of which are controlled at high level, all powders capable of forming images such as toners are included. For example, luster restraint powders, luster grant powders and foamable powders are included as well. A toner as a powder is explained.

A process cartridge indicates and includes a device prepared by integrating one or all of component elements (i.e., members or devices) needed to form an image, and at least includes a latent image bearer, in other words, an electrophotographic photoreceptor (herein after, sometimes simply referred to as a photoreceptor).

The process cartridge also sometimes indicates and includes one or all of component elements needed to execute various processes in the electrophotographic system, such as an electrostatic charging process, a process of forming an electrostatic latent image executed by writing an image, a process of rendering the electrostatic latent image visible with toner in one-component developer, a process of transfer the toner image thus developed onto the paper sheet or the intermediate transfer member, and that of cleaning the electrophotographic photoreceptor after the toner image transfer process.

Next, details of an embodiment of the image forming apparatus of the present invention are explained.

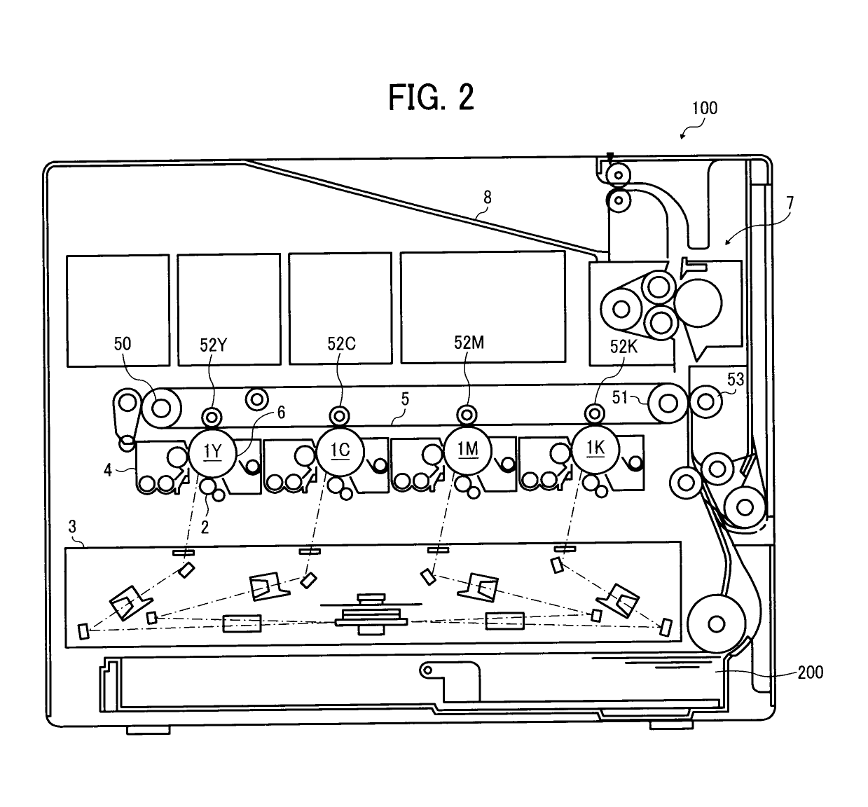

FIG. 2 is a schematic view illustrating an embodiment 1 of the image forming apparatus of the present invention. The image forming apparatus is a full-color image forming apparatus capable of electrophotographically forming full-color images, which can be used as a full-color POD (printer on demand).

An image forming unit included in the image forming apparatus 100 includes multiple electrophotographic photoreceptors 1Y, 1C, 1M, and 1K. These photoreceptors 1Y, 1C, 1M, and 1K are provided in a conveyance direction of the intermediate transfer belt 5. Herein below, when the electrophotographic photoreceptors 1Y, 1C, 1M, and 1K are referred to in a block, it is simply referred to as the electrophotographic photoreceptor 1.

These photoreceptors 1Y, 1C, 1M, and 1K may be drum-shaped and bear toner images of respective colors (for example, yellow, cyan, magenta, and black) including photoconductive layers. The images are written onto the electrophotographic photoreceptor 1 by an optical writing unit 3. Around each of the electrophotographic photoreceptors 1Y, 1C, 1M, and 1K, an electrostatic charging unit 2, a writing unit 3, a developing unit 4, an intermediate transfer belt 5, and a cleaning unit 6 are deployed.

The intermediate transfer belt 5 is stretched and wound around a pair of rollers 50 and 51. Inside the intermediate transfer belt 5, corresponding to respective photoreceptors 1, multiple primary transfer rollers as primary transfer devices 52Y, 52C, 52M, and 52K are disposed. Also, at a location opposite the roller 51, a secondary transfer roller 53 as a secondary transfer device is disposed to transfer an overlaid image from the intermediate transfer belt 5 onto the recording medium at once.

The writing unit 3 is used in an electrostatic latent image forming process, but is not limited to a particular device that forms an electrostatic latent image. In other words, any type of the writing unit 3 can be employed if it can form the electrostatic latent image after the electrophotographic photoreceptor 1 is electrically charged by the electrostatic charging unit 2 as described below more in detail.

As an electrostatic charging system implemented in the above-described electrostatic charging process, a system that applies a voltage onto a surface of the electrophotographic photoreceptor 1 with the below described electrostatic charging unit 2 can be used, for example.

The electrostatic charging unit 2 used in the electrostatic charging process is not limited to a particular type, and can appropriately choose any type depending on a usage purpose. For example, a known contact type electrostatic charging unit that includes one of a conducting or semiconductive roller, a brush, a film, and a rubber blade or the like can be used. Also used is a non-contact type electrostatic charging system that uses a corona discharging system, such as a corotron charger, a scorotron charger, etc. Especially, a so-called roller type electrostatic charging unit that brings the conducting or semiconductive roller, to which a DC (Direct Current) voltage is applied, in contact with the electrophotographic photoreceptor 1 is preferably employed to electrostatically charge thereof while avoiding generation of discharged products such as ozone, etc. Also, when a contact type electrostatic charging unit having an electrically charging roller is used, a soft contact type electrostatic charging roller or an electrostatic charging unit omitting a pressure member not to apply great pressure to a contact section therebetween is more favorably employed.

The writing unit 3 used in the electrostatic latent image forming process can expose a surface of the electrophotographic photoreceptor using a writing exposure unit, for example, in accordance with an image.

The writing exposure unit is not limited to a particular type and can choose any type depending on a usage purpose if it can expose a prescribed position on a surface of the electrophotographic photoreceptor corresponding to an image to be formed thereon after it is electrically charged by the electrostatic charging unit 2. For example, various writing exposure units, such as a copier optical system, a rod lens array system, a laser optical system, an LCD (Liquid Crystal Display) shutter optical system, an LED (Light Emitting Diode) optical system, etc., can be employed. A backside writing system may also be adopted to provide writing exposure to the electrophotographic photoreceptor from a backside thereof in accordance with the image.

The developing unit 4 used as a developing unit forms a visible image by developing an electrostatic latent image formed on the electrophotographic photoreceptor 1 using a developer. The developing unit 4 has a developing sleeve, a one-component developer agitation supplier. The developing sleeve bears and conveys the developer to a position facing the electrophotographic photoreceptor. Between the electrophotographic photoreceptor and the developing sleeve, there is formed a developing gap through the developer. Since the developing gap is formed by taking a supplying amount of the developer onto the developing sleeve, a magnetic field intensity to hold the developer on the developing sleeve, magnetization of a carrier in the developer, and a rotational speed of the developing sleeve or the like into account, it cannot be necessarily predetermined. However, generally, an average value of the developing gap is preferably from about 0.2 mm to about 0.4 mm. The developing unit 4 is not limited to a particular type and any type can be chosen from among publicly known types if it meets the above-described conditions. For example, the developing unit 4 at least preferably includes a container capable of containing a sufficient amount of the developer and a developing unit that can provide the developer to the electrostatic latent image while either contacting or not contacting thereto.

The developer includes a one-component developer including only a toner and a two-component developer including a toner and a carrier. The toner can be appropriately chosen depending on a usage purpose. However, an average roundness of the toner (e.g., an average of roundness SR) represented by the following first formula is preferably from about 0.94 to about 1.00, and is more preferably from about 0.96 to about 0.99. This average roundness indicates a degree of unevenness of the toner particle and is 1.00 when the toner is perfectly spherical. Thus, the average roundness decreases as a shape of a surface of the toner particle becomes complex.

Roundness SR=Circumference of circle having the same area as projection area of toner particle/Circumference of toner particle (First Formula)

A weight-average particle diameter (D4) of toner is not limited to a particular value and can be appropriately chosen depending on a usage purpose. However, the mass average particle diameter (D4) of toner is preferably from about 3 μm to about 10 μm and is more desirably from about 4 μm to about 8 μm. Because, in this range, dot reproduction performance is relatively excellent because the toner particle having a sufficiently small diameter is included corresponding to a very small latent image dot. Further because, when the mass average particle diameter (D4) is below 3 μm, transfer efficiency and blade cleaning performance likely readily deteriorate. Whereas, when the mass average particle diameter (D4) exceeds 10 μm, it may be difficult to suppress scattering of characters and lines.

As the cleaning unit 6 used in the cleaning process is not limited to a particular type and can be appropriately chosen depending on a usage purpose if it can clean the electrophotographic photoreceptor surface. For example, a cleaning blade that cleans the photoreceptor surface is preferably employed. In general, however, as the cleaning unit that cleans the electrophotographic photoreceptor 1, an electrostatic cleaning unit with a brush, to which a bias voltage having a reverse polarity to that of toner remaining on the electrophotographic photoreceptor 1 is applied, is employed beside the system using the cleaning blade.

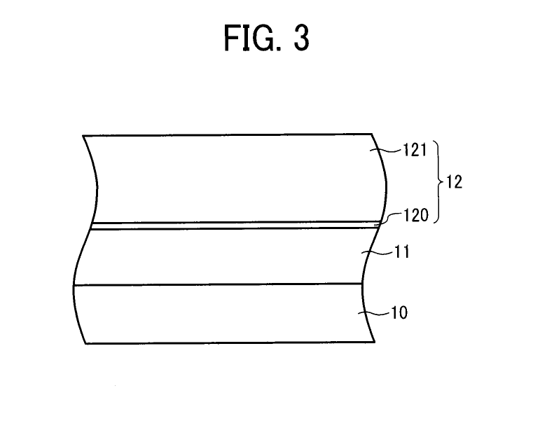

Now, an electrophotographic photoreceptor used in an image forming process as a latent image bearer is described in more detail with reference to FIG. 3 that schematically illustrates one example of the electrophotographic photoreceptor 1 with a partially enlarged view.

The photoreceptor 1 includes a substrate 10, an undercoat layer 11, and a photosensitive layer 12. The photosensitive layer 12 includes a charge generation layer 120 and a charge transport layer 121. Now, the substrate 10, the undercoat layer 11, and the photosensitive layer 12 are herein below described more in detail.

### [Substrate]

Initially, the substrate 10 is herein below described more in detail. The substrate 10 used in the electrophotographic photoreceptor 1 is preferably conductive having a volume resistance of less than about 1.0×10¹⁰ Ω/cm. However, any material can be chosen depending on a usage purpose. For example, the substrate 10 is prepared by covering plastic or tempered glass and the like with metal oxide, such as aluminum, nickel, chrome, nickel-chrome, copper, gold, silver, platinum, tin oxide, indium oxide, etc., by applying vapor deposition or sputtering thereto. The substrate 10 can be also prepared by initially producing an original pipe by either extruding or drawing one of aluminum, aluminum alloys, nickel, and stainless steel or the like, and subsequently applying surface treatment processes thereto, such as cutting, finishing, polishing, etc. The substrate 10 is preferably either a circular rigid pipe or a thin cylindrical member with sufficient tensile strength to obtain prescribed alignment precision and dimensional stability or the like needed in the image forming process.

The diameter of the substrate 10 is not limited to a particular size, and can be optionally chosen depending on a usage purpose. However, the diameter of the substrate 10 of from about 20 mm to about 150 mm is generally preferable, and is more preferably from about 24 mm to about 100 mm. A yet further particularly preferable diameter of the substrate 10 is of from about 28 mm to about 70 mm. Specifically, when the diameter of the substrate 10 is below about 20 mm, it becomes physically difficult to arrange the electrostatic charging unit, the exposing unit, the developing unit, the transfer device, and the cleaning unit around the electrophotographic photoreceptor 1. By contrast, when the diameter of the substrate 10 exceeds about 150 mm, the image forming apparatus 100 may be upsized.

### [Undercoat Layer]

Next, the undercoat layer 11 is herein below described more in detail. The above-described undercoat layer 11 is not limited to a particular type and may be composed of one or more layers. For example,
(1) the undercoat layer 11 can be made of one of material including resin as a main component, that including electron receiving material,
(2) N-type semiconductor particles, and resin as a main component, and
(3) an oxidized metal film prepared by chemically or electrochemically oxidizing a surface of a conductive substrate or the like.

Among those, the material made of the electron receiving materials, N-type semiconductor particles, and resin as a main component is most preferably employed as the undercoat layer 11.

As the above-described electron receiving material, every material can be used if it can provide desired characteristics thereof. However, prescribed material having high affinity with the N-type semiconductor particle is preferably used. For example, a chemical compound having an anthraquinone structure with a hydroxyl group as a basic skeleton, such as a hydroxy anthraquinone chemical compound, an amino hydroxy-anthraquinone chemical compound, etc., may be preferably used. Specifically, 1,2-dihydroxy-9,10-anthraquinone; 1,4-dihydroxy-9,10-anthraquinone; 1,5-dihydroxy-9,10-anthraquinone; 1,2,4-trihydroxy-9,10-anthraquinone; 1-hydroxyanthraquinone; 2-amino-3-hydroxyanthraquinone; and 1-amino-4-hydroxyl-anthraquinone or the like as exemplified. Otherwise, a fullerene derivative, such as phenyl-C61-butyric acid methyl ester, phenyl-C61-butyric acid butyl ester, phenyl-C61-butyric acid isobutyl ester, etc., can be also used as the electron receiving material as well.

The above-described N-type semiconductor particle is not limited to a particular type, and a particle made of metal oxide, such as zinc oxide, dioxide tin, indium oxide, ITO ((Indium Tin Oxide) e.g., In₂O₃:SnO₂=90:10 [WT (weight) %]), etc., or that prepared by processing a substrate particle made of inorganic oxide with these materials (i.e., metal oxide) can be used.

Also, the above-described resin is not limited to a particular type, and thermoplastic resin, such as for example, polyamide, polyvinyl alcohol, casein, methyl cellulose, etc., and thermosetting plastic, such as acrylic, phenol, melamine, alkyd, unsaturated polyester, epoxy, etc., can be used as well. Each of these may be used alone or being combined with the other one or more material.

Since a thickness of the above-described undercoat layer 11 preferably changes in accordance with a kind and a combination of usage materials, a range thereof cannot not be predetermined. However, the thickness of the above-described undercoat layer 11 is preferably from about 0.5 μm to about 20 μm. In particular, to precisely prevent electrical charge injection from the substrate 10 while quickly attenuating an electrical charge generated in the charge generation layer and a surplus electrical charge generated during the electrostatic charging process as well, a value of from about 2 μm to about 15 μm is more favorably employed.

### [Photosensitive Layer]

Now, the photosensitive layer 12 is herein below described more in detail. The above-described photosensitive layer 12 is not limited to a particular type, and any type can be appropriately chosen depending on a usage purpose. For example, a single-layer type photosensitive layer prepared by mixing a charge generation material and a charge transport material, a normal order layer type photosensitive layer prepared by stacking a charge transport layer containing the charge transport material on a charge generation layer containing a charge generation material, or a reverse layer type photosensitive layer prepared by stacking the charge generation layer on the charge transport layer is utilized. Here, a proper quantity of plasticizer, antioxidant, and a leveling agent may be added to each of the layers as needed. The thickness of the photosensitive layer 12 is not limited to a particular size, and any size can be appropriately chosen depending on a usage purpose. However, a value of from about 10 μm to about 50 μm is desirable. As the total thickness of the above-described undercoat layer 11 and the photosensitive layer 12, a value of from about 20 μm to about 60 μm is desirable. Because, when it is used satisfying the above-described range, a visible image can be uniformly formed for a long time, and accordingly, a stable image forming apparatus capable of reducing chronological fluctuations can be obtained. By contrast, however, when the thickness is below 20 μm, electrical uniformity of the electrophotographic photoreceptor is sometimes difficult to keep. When the thickness exceeds 60 μm, resolution of a latent image may undesirably deteriorate.

As the charge generation material included in the photosensitive layer 12, a chemical compound with a tetrabenzo porphyrin skeleton or the like is exemplified. As the chemical compound having the tetrabenzo porphyrin skeleton, unsubstituted tetrabenzo porphyrin, a complex prepared by introducing copper, silver, gold, platinum, nickel, calcium, strontium, barium, titanium, manganese, iron, cobalt, nickel, aluminum, and gallium or the like as central metal, and a chemical compound prepared by introducing alkyl group, phenyl group, halogen group, hydroxyl group, amino group, nitro group, and carboxyl group or the like as characteristic groups are exemplified. These are selectively used as necessary.

Also, as the charge generation material, azo pigments, such as monoazo system pigments, bisazo pigments, trisazo pigment, tetrakisazo pigments, etc., may be used as well. Also used as the charge generation material is organic pigments or dye, such as triaryl methane dyes, thiazine dyes, oxazine dyes, xantene dyes, cyanine dyes, styryl dye, pyrylium salt dyes, quinacridone pigment, indigo pigment, perylene pigment, multiple polycyclic quinone pigments, bisbenzimidazole pigment, indanthrene pigments, squarylium pigments, phthalocyanine pigment, etc. Yet also used is inorganic material, such as titanium oxide, a cadmium sulfide, zinc oxide, etc. These materials can be used together in various combinations as well.

As the charge transport material included in the photosensitive layer 12, anthracene derivatives, pyrene derivatives, carbazole derivatives, tetrazole derivatives, metallocene derivatives, phenothiazine derivatives, pyrazoline chemical compounds, hydrazone chemical compounds, styryl chemical compounds, styryl hydrazone chemical compounds, enamine chemical compound, butadiene chemical compound, distyryl chemical compounds, oxazole chemical compounds, oxadiazole chemical compounds, thiazole chemical compound, imidazole chemical compounds, triphenylamine derivatives, phenylenediamine derivatives, triphenylmethane derivatives, aminostilbene derivatives are exemplified, for example. These may be used alone or together with the other one or more types.

Binder resin included in the photosensitive layer 12 has moderate electrical insulation performance and can itself employ known thermoplastic resin, thermosetting resin, light curable resin, and photoconductive resin or the like. For example, as the binder resin of the thermoplastic resin, polyvinyl chloride, polyvinylidene chloride, vinyl chloride-vinyl acetate copolymer, vinyl chloride-vinyl acetate-anhydrous maleic acid copolymer, ethylene-acetic acid vinyl copolymer, polyvinyl butyral, polyvinyl acetal, polyester, phenoxy resins, (meta) acrylic resin, polystyrene, polycarbonate, polyarylate, polysulfone, polyethersulfone, ABS resin, etc., are exemplified. Also exemplified as the binder resins of the thermosetting resin are phenolic resin, epoxy resin, polyurethane resin, melamine resin, isocyanate resin, alkyd resin, silicone resin, thermosetting acrylic resins, etc. Yet also exemplified as the binder resins are polyvinylcarbazole, polyvinyl anthracene, and polyvinyl pyrene or the like are exemplified. These may be used alone or together with the other one or more types. As an oxidation inhibitor included in the photosensitive layer, a phenolic chemical compound, p-phenylenediamine class, hydroquinone class, organic sulfur chemical compound class, and organic phosphorus chemical compound class or the like can be exemplified. As the above-described phenolic chemical compound, 2,6-di-t-butyl-p-cresol; butylated hydroxyanisole; 2,6-di-t-butyl-4-ethylphenol; stearyl-β-(3,5-di-t-butyl-4-hydroxyphenyl)propionate; 2,2′-methylene-bis-(4-methyl-6-t-butylphenol); 2,2′-methylene-bis-(4-ethyl-6-t-butylphenol); 4,4′-thiobis-(3-methyl-6-t-butylphenol); 4,4′-butylidenebis-(3-methyl-6-t-butylphenol); 1,1,3-tris-(2-methyl-4-hydroxy-5-t-butyl phenyl) butane; 1,3,5-trimethyl-2,4,6-tris(3,5-di-t-butyl-4-hydroxybenzyl)benzene; tetrakis-[methylene-3-(3′,5′-di-t-butyl-4′-hydroxyphenyl)propionate]methane; bis[3,3′-bis(4′-hydroxy-3′-t-butylphenyl) butyric acid]glycol ester; and tocopherol classes or the like are exemplified. As the above-described p-Phenylenediamine class, N-phenyl-N′-isopropyl-p-phenylenediamine; N,N′-di-sec-butyl-p-phenylenediamine; N-phenyl-N-sec-butyl-p-phenylenediamine; N,N′-di-isopropyl-p-phenylenediamine; N,N′-dimethyl-N,N′-di-t-butyl-p-phenylenediamine or the like are exemplified. As the above-described hydroquinone class, 2,5-di-t-octyl hydroquinone; 2,6-didodecyl hydroquinone; 2-dodecyl hydroquinone; 2-dodecyl-5-chlorohydroquinone; 2-t-octyl-5-methyl hydroquinone; and 2-(2-octadecenyl)-5-methyl hydroquinone or the like are exemplified. As the above-described organic sulfur chemical compound, dilauryl-3,3′-thiodipropionate; distearyl-3,3′-thiodipropionate; and ditetradecyl-3,3′-thiodipropionate or the like are exemplified. As the above-described organic phosphorus chemical compounds, triphenylphosphine, tri(nonylphenyl)phosphine, tri(dinonylphenyl)phosphine, and tricresylphosphine, tri(2,4-dibutylphenoxy)phosphine or the like are exemplified.

These chemical compounds are known as antioxidants for rubber, plastic, and oil and fat or the like, and are readily available commercially. An addition of the antioxidant is favorably from about 0.01% to about 10% by weight based on total weight of an adding target layer.

As a plasticizer included in the photosensitive layer 12, general resin plasticizers, such as dibutyl phthalate, dioctyl phthalate, etc. are used as they are. A usage amount of the plasticizer is preferably from about 0 to 30 parts by weight per 100 parts by weight of the binder resin.

A leveling agent may be added to the photosensitive layer 12. As the leveling agent, silicone oils such as dimethyl silicone oils and methylphenyl silicone oils; polymers or oligomers having a perfluoroalkyl group as a side chain are used. A usage amount of the leveling agent is desirably from about 0 to about 1 part by weight per 100 parts by weight of the above-described binder resin.

Now, an image forming process implemented by using the above-described image forming stations of respective colors is described herein below. A series of the image forming processes is initially described using a negative to positive process. However, all of photoreceptors and all of developing units are commonly described, the electrophotographic photoreceptor is simply indicated by the reference numeral 1 and the developing unit by the reference numeral 4, respectively.

Prior to the image formation, the electrophotographic photoreceptor 1 having a photoconductive layer is negatively charged uniformly with electricity by the electrostatic charging unit 2 having an electrostatic charging unit. When the electrophotographic photoreceptor 1 is electrically charged by the electrostatic charging unit 2, a prescribed amount of electrical charge voltages enabling the electrophotographic photoreceptor 1 to bear the later described potential is applied from the later described voltage applying system to the electrostatic charging unit.

On the electrically charged photoreceptor 1, a latent image is formed by emitting a laser light beam thereonto from the writing unit 3 such as a laser optical system, etc. Specifically, the laser light emanates from a semiconductor laser, and scans a surface of the electrophotographic photoreceptor 1 in a rotary axis direction of the electrophotographic photoreceptor 1 as a polygonal prism (i.e., a polygon mirror) or the like rotates at high speed.

The electrostatic latent image formed in this way is developed by a developer composed of toner particles supplied to the developing sleeve 40 installed in the developing unit 4, thereby forming a toner visualizing image. During developing the electrostatic latent image, a developing bias having either a prescribed DC (Direct Current) voltage or a superimposed voltage prepared by superimposing the DC voltage with an AC (Alternating Current) voltage having a value between potentials of an exposed area and a non-exposed area on the electrophotographic photoreceptor 1 is applied from a developing bias applying system to the developing sleeve.

The toner images formed on the electrophotographic photoreceptors 1Y, 1C, 1M, and 1K corresponding to respective colors are sequentially transferred onto the intermediate transfer belt 5 by the primary transfer rollers 52Y, 52C, 52M, and 52K acting as primary transfer devices. At this moment, to the primary transfer roller 52, a voltage having a reverse polarity to an electrical charge polarity of the toner may be preferably applied as a transfer bias. Subsequently, an intermediate transfer belt 5 is separated from photoreceptor 1, and a transferred image is obtained. The superimposed image on the intermediate transfer belt 5 is transferred at once onto a recording medium such as a sheet, etc., fed from the sheet feeding unit 200 by the secondary transfer roller 53.

The recording medium fed from the sheet cassette chosen from the sheet feeding unit 200 once stops at a pair of registration rollers to correct its skew (i.e., inclined deviation of a sheet), and is subsequently conveyed at a predetermined time toward the secondary transfer roller 53 provided in the secondary transfer section. The recording medium with the superimposed image transferred thereon at once is further sent to a fixing device 7, so that the toner image can be fixed there by pressure and heat. The recording medium completing the fixing process is subsequently ejected by a pair of sheet exit rollers and is stacked on a sheet exit tray 8.

Residual toner particles remaining on the electrophotographic photoreceptor 1 after the primary transfer process is removed and collected by the cleaning unit 6. Toner particles remaining on the intermediate transfer belt 5 after the second transfer process are also removed and collected by an intermediate transfer belt cleaning unit. That is, the secondary transfer device is employed in the image forming apparatus by using the intermediate transfer belt 5 in this practical example. Alternatively, however, the multiple toner images borne on more than one photoreceptor 1 can be sequentially transferred and stacked on the same position a recording medium conveyed by a conveyor belt.

### EXAMPLES

Having generally described this invention, further understanding can be obtained by reference to certain specific examples which are provided herein for the purpose of illustration only and are not intended to be limiting.

Based on the above-described configuration, image quality of a practical example is compared with that of a comparative example and a comparison result is obtained through the following various experiments as listed below.

First, evaluation results shown in Table 1 are explained.

TABLE 1

| | Process | Discharge | | | | | | |
|---|---|---|---|---|---|---|---|---|
| | Speed | Treatment | | | | Surface | | |
| | (mm/ | Voltage | | Spray Treatment | | Resistivity | | |
| | sec) | (kV) | | Liquid | | (Ω) | Transferability | Chargeability |
| Ex. 1 | 50 | 2.0 | Yes | Solution 1 | Yes | 1.4 × 10¹⁰ | Good | Good |
| Ex. 2 | 300 | 2.0 | Yes | Solution 1 | Yes | 8.5 × 10¹⁰ | Good | Good |
| Ex. 3 | 50 | 1.8 | Yes | Solution 1 | Yes | 2.0 × 10¹⁰ | Good | Good |
| Ex. 4 | 300 | 1.8 | Yes | Solution 1 | Yes | 1.1 × 10¹¹ | Fair | Fair |
| Ex. 5 | 50 | 2.0 | Yes | Solution 2 | Yes | 5.7 × 10¹² | Fair | Good |
| Ex. 6 | 30 | 2.0 | Yes | Solution 2 | Yes | 9.5 × 10¹² | Fair | Good |
| Com. Ex. 1 | 50 | 2.0 | Yes | — | No | 1.0 × 10¹³ | Poor | Poor |
| | | | | | | or greater | | |
| Com. Ex. 2 | 50 | — | No | Solution 1 | Yes | 2.1 × 10¹⁰ | Fair | Poor |
| Com. Ex. 3 | — | — | No | — | No | 1.0 × 10¹³ | Poor | Poor |
| | | | | | | or greater | | |
| Ref. Ex. 1 | — | — | No | — | No | 2.2 × 10¹¹ | Good | Good |

### <Transferability>

Good: No uneven image density all over the surface
Fair: Slight uneven image density, but no problem in practical use
Poor: Uneven image density is apparently recognizable, and unusable

### <Fixability>

Good: No toner peeling
Fair: Slight toner peeling, but no problem in practical use
Poor: Toner peeling is apparently recognizable, and unusable

### Example 1

A charger and an intermediate transfer unit used in MFP Imagio MP C5002 from Ricoh Company, Ltd. were taken out, and a line type binary fluid spray, a liquid supplier, a squeeze roller, a blower, a drive system and a control system which are separately prepared were installed therein to prepare a surface processor of recording media having the configuration in FIG. 1. Polyethylene glycol as a toner affinity ingredient, dialkyl dimethyl ammonium salt as an antistatic agent ingredient, and a mixed solvent including ethanol and water were cast into the liquid supplier at a weight ratio of 10/0.5/89.5 to prepare a solution 1. A white polypropylene sheet (thickness 0.3 mm and A3 size) the both surfaces of which were processed was used as a recording medium. The conveyance speed of the recording medium was 50 mm/sec, and an alternating voltage of 2.0 kV between peaks was applied to the charger. The intermediate transfer belt used as a conveyance belt of the recording medium was earthed through a metal roller on which the belt was hung on. The solution including the toner affinity ingredient supplied to the binary fluid spray with compressed air from a compressor separately prepared, and was sprayed on the recording medium just after it passed the charger.

The surface of the recording medium the solution was applied to was scraped with a squeeze roller (reverse turns relative to travel direction of the recording medium) to remove the surplus solution and equalize the liquid adhering to the surface of the recording medium.

The recording medium passed a ventilation dryer to be a surface-treated recording medium.

An electrical resistance of the surface-treated recording medium measured by a high resistance resistometer Hirester HT-201 from Mitsubishi Petrochemical Co., Ltd. at a voltage 500V for 10 sec. was 1.4×10¹⁰Ω. The surface-treated recording medium was directly provided to a manual feed unit of an on-demand printer RICOH Pro C901 from Ricoh Company, Ltd. to form a full-scale blue image. The uneven image density of the resultant images was visually evaluated and the fixability thereof was evaluated by a drawing tester AD-2110 from Ueshima Seisakusho Co., Ltd. The load of the drawing tester was 100 g, a movement stage was fixed, and the same point was rubbed 100 times to visually evaluate the toner peeling. The transferability and the fixability were both good. The surface processing conditions and the evaluation results are the same as those shown in Table 1.

### Example 2

The procedure for surface process in Example 1 was repeated except for changing the surface processing speed to 300 mm/sec. The surface processing conditions and the evaluation results are the same as those shown in Table 1.

### Examples 3 and 4

The procedures for surface process in Examples 1 and 2 were repeated except for changing the alternating voltage between peaks to 1.8 kV, respectively. The surface processing conditions and the evaluation results are the same as those shown in Table 1.

### Examples 5 and 6

The procedures for surface process in Examples 1 and 2 were repeated except for changing the solution 1 to a solution including the polyethylene glycol as a toner affinity ingredient and a mixed solvent including ethanol and water at a weight ratio of 10/90, respectively. The surface processing conditions and the evaluation results are the same as those shown in Table 1.

### Comparative Example 1

The procedure for surface process in Example 1 was repeated without discharge treatment. The surface processing conditions and the evaluation results are the same as those shown in Table 1.

### Comparative Example 2

The procedure for surface process in Example 1 was repeated without spray treatment. The surface processing conditions and the evaluation results are the same as those shown in Table 1.

### Comparative Example 3

The procedure for surface process in Example 1 was repeated except for using an untreated white propylene sheet. The surface processing conditions and the evaluation results are the same as those shown in Table 1.

### Reference Example 1

The procedure for surface process in Example 1 was repeated except for using a coated paper (POD gloss coat) for electrophotographic image forming apparatus as a recording medium. The surface processing conditions and the evaluation results are the same as those shown in Table 1.

### Embodiment 2

In the present invention, the surface of a recording medium is previously activated and ingredients are applied to the activated surface of the recording medium. Namely, the ingredients can be applied to various recording media without releasing. It is preferable to supply a toner affinity ingredient as a solution and/or a dispersion liquid when it is applied by the applicator 94 to stabilize and equalize the adherence quantity thereof. It is necessary to limit consumption of inorganic conductive materials when chosen because of including a lot of colored materials.

In this embodiment, the surface processing conditions are set depending on the characteristics of a recording medium previously memorized in a memory of the imaging forming apparatus. Therefore, it is necessary to memorize the characteristic of the recording medium prior to image formation. Specific examples of the memories include, but are not limited to, electrical means represented by nonvolatile memory, magnetic means represented by a magnetic disk drive and optical means represented by an optical disk drive. The characteristics of the recording medium to be memorized in the memory preferably include surface properties thereof as described so far such as surface electrical properties represented by a surface electrical resistance and an impedance and a surface wet properties represented by a contact angle and a surface tension of the recording medium together with a name and a cord to distinguish the recording medium.

The memorized characteristics of the recording medium is called by choosing the name and the cord to identify the recording medium, and conditions of surface processing of the surface processor are set on the basis of this. The process conditions of the surface processor include setting conditions such as a reforming energy amount to the surface reformer, e.g., a discharge voltage, a lamp light quantity and a plasma discharge quantity, and an adherence amount of the toner affinity ingredient, e.g., a spray amount, a revolution number of coating roller and a feed amount. As a setting standard, a setting condition reference table separately prepared for each characteristic of the recording medium may be used.

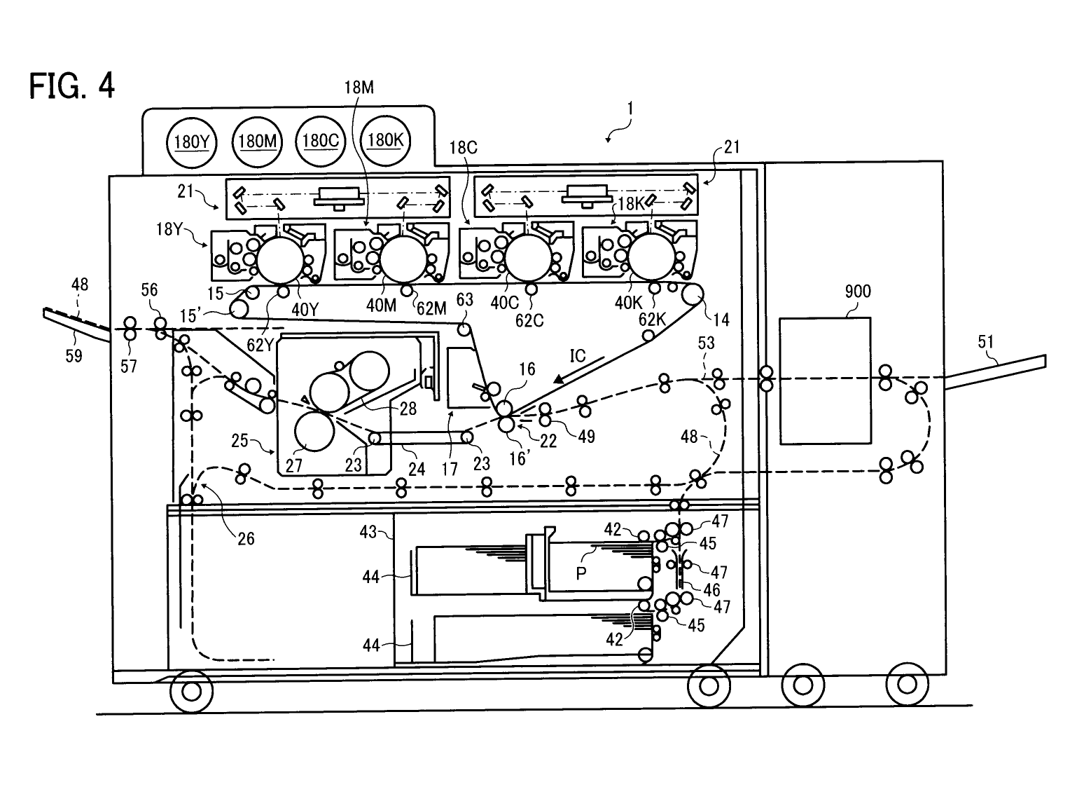

FIG. 4 is a schematic view illustrating an embodiment 2 of the image forming apparatus of the present invention. Configurations thereof which are the same as those in FIG. 2 have the same codes or explanations thereof are omitted.

An image forming apparatus 1 includes a pair of registration rollers 49, a manual feeding out roller 50, a manual feed tray 51, a manual paper feed path 53, a conveyance reverser 28, a pair of paper ejection rollers 56 after a toner image is fixed on a recording medium P, a pair of conveyance rollers 57 and 58 conveying the recording medium P a toner image is fixed on, and a paper ejection tray 59, etc. to form a recording medium conveyance path 48 through which the recording medium P as a transfer material supplied from a paper feeder 43 having two paper feed cassettes 44 is conveyed and output.

In addition, the image forming apparatus 1 includes an intermediate transfer unit transferring a toner image formed in process units 18Y, M, C and K onto a recording medium P through an intermediate transfer belt 10 as an intermediate transferer; a fixer 25 fixing the toner image on the recording medium P; a conveyance belt unit conveying the recording medium the toner image is transferred onto with a conveyance belt 24 hung on support rollers 23 to the fixer 24; and a transfer paper refeeder 28 to form toner images on both sides of the recording medium P. The image forming apparatus 1 further includes a surface processor 900 processing the surface of a recording medium P fed from the paper feeder 43 or the manual feed tray 51.

Each of the paper feed cassettes 44 contains a bundle of the recording media P, and a recording medium P on the top of the bundle of the recording media is fed out by rotation of a paper feed roller 42. The recording medium P fed out from the paper feed cassettes 44 is conveyed to the recording medium conveyance path 48 by a paper feed rollers 45 and 47 through a paper feed path 46. The manual feed tray 51 is openably and closably located on the side of a chassis, and a bundle of the recording media P is manually fed on the tray while opened. A recording medium P on the top of the bundle of the recording media manually fed out by manual feed roller 50 to the recording medium conveyance path 48.

Each of two writing units 21 has a laser diode, a polygon mirror and various lenses, and drives a light source such as LDs to optically scan photoreceptors 40Y, M, C and K of the process units 18Y, M, C and K on the basis of image information from an outer image reader (scanner) or a computer. Specifically, each of the photoreceptors 40Y, M, C and K of the process units 18Y, M, C and K is driven by an unillustrated driver to rotate anticlockwise. The writing unit 21 on the left side of FIG. 4 irradiates the rotating photoreceptors 40Y and M with a laser beam while deflecting the laser beam linearly in the rotational axis direction to optically scan them. Thus, an electrostatic latent image based on each of Y and M image information is formed on each of the photoreceptors 40Y and M.

The writing unit 21 on the right side of FIG. 4 irradiates the rotating photoreceptors 40C and K with a laser beam while deflecting the laser beam linearly in the rotational axis direction to optically scan them. Thus, an electrostatic latent image based on each of C and K image information is formed on each of the photoreceptors 40C and K.

Each of the four process units 18Y, M, C and K has a drum-shaped photoreceptors 40Y, M, C and K as a latent image bearer. Each of the four process units 18Y, M, C and K supports various devices arranged around each of the photoreceptors 40C and K on a common supporter as one unit, and they are attachable and detachable to and from the image forming apparatus. The process units 18Y, M, C and K have the same configurations except for using toners having colors different from each other. The image forming apparatus 1 has a tandem-type configuration locating the four process units 18Y, M, C and K in line along an endless travel direction of the intermediate transfer belt 10 so as to face stretched part thereof between support rollers.

For example, the process unit 18Y forming a yellow (Y) toner image has, besides the photoreceptor 40Y, an image developer developing an electrostatic latent image formed on the surface thereof to form a Y toner image. In addition, it has a charger uniformly charging the surface of the photoreceptor 40Y driven to rotate, and a drum cleaner removing a residual toner adhering to the surface thereof after passing a first transfer nip for Y, etc. The charger, the image developer and the drum cleaner are located in line in this order in a rotational direction of the photoreceptor 40Y.

The photoreceptor 40Y has the shape of a drum including a cylinder formed of aluminum, etc., and a photosensitive layer coated thereon with an organic photosensitive material. The photoreceptor 40Y may have the shape of an endless belt.

The image developer for yellow (Y) forms a latent image with a two-component developer (hereinafter referred to as a “developer”) including a magnetic carrier and a non-magnetic Y toner. The image developer may use a one-component developer not including a magnetic carrier instead of the two-component developer. A Y toner in a Y toner bottle 180 is properly supplied by an unillustrated Y toner supplier. A toner usable in the image developer in each of the process units 18Y, M, C and K is explained later.

The drum cleaner for Y presses a cleaning blade formed of a polyurethane rubber against the photoreceptor 40Y, and may use other methods of cleaning. For the purpose of improving cleanability, a rotatable fur brush may contact the photoreceptor 40Y. The fur brush scrapes a solid lubricant and forms a fine powder thereof to apply the powder to the surface of the photoreceptor 40Y as well.

An unillustrated discharge lamp is located above the photoreceptor 40Y, which is a part of the process unit 18Y as well. The discharge lamp irradiates the surface of the photoreceptor 40Y after having passed the drum cleaner with light to discharge the surface thereof. After the discharged surface of the photoreceptor 40Y is uniformly charged by a charger, it is optically scanned by the optical writing unit 21 for Y. The charge is driven to rotate while provided with a charging bias from an unillustrated electrical source. A scorotron charger charging the photoreceptor 40Y without contacting thereto may be used.

The process unit 18Y for Y has been explained, and each of the process units 18M, C and K has the process units 18Y, M, C and K the process units 18Y, M, C and K the same configuration as the process unit 18Y.

The intermediate transfer unit is located below the four process units 18Y, M, C and K. The intermediate transfer unit endlessly moves the intermediate transfer belt 10 hung on and stretched by plural rollers 14, 15, 15′, 16 and 63 clockwise with the rotation of one of the rollers while contacting the intermediate transfer belt 10 to the photoreceptors 40Y, M, C and K. Thus, the photoreceptors 40Y, M, C and K contact the intermediate transfer belt 10 to form first transfer nips for Y, M, C and K.

Near each of the first transfer nips for Y, M, C and K, first transfer rollers 62Y, M, C and K as first transfer member located inside of the loop of the intermediate transfer belt 10 press the belt toward the photoreceptors 40Y, M, C and K. Each of the first transfer rollers 62Y, M, C and K is applied with a first transfer bias with an unillustrated electrical source. Thus, a first transfer electrical field electrostatically transferring a toner image on each of the photoreceptors 40Y, M, C and K onto the intermediate transfer belt 10 is formed in each of the first transfer nips for Y, M, C and K.

While sequentially passing the first transfer nips for Y, M, C and K with endless rotation of the intermediate transfer belt 10, toner images are sequentially transferred at each of the first transfer nips and overlapped on the outer surface of the intermediate transfer belt 10. Thus, a four color overlapped toner image (hereinafter referred to as a “four-color toner image”) is formed on the outer surface of the intermediate transfer belt 10.

A second transferer roller 16′ as a second transfer member is located at a second transfer part 22 below the intermediate transfer belt 10. The second transferer roller 16′ contacts the outer surface of the intermediate transfer belt 10 against a second transfer backup roller 16 to form a second transfer nip.

The second transferer roller 16′ is applied with a second transfer bias by an unillustrated electrical source. The second transfer backup roller 16 in the loop of the belt is earthed. Thus, a second transfer electric field is formed in the second transfer nip.

A pair of the registration rollers 49 are located on the right side of the second transfer part 22, and feed a recording medium P sandwiched therebetween to the second transfer nip in synchronization with the four-color toner image on the intermediate transfer belt 10. In the second transfer nip, the four-color toner image on the intermediate transfer belt 10 is transferred onto a recording medium P by the second transfer electric filed and the nip pressure to form a full-color image with white color of the recording medium P.

An untransferred residual toner which has not been transferred onto a recording medium P at the second transfer nip adheres to the outer surface of the intermediate transfer belt 10 having passed the second transfer nip. The untransferred residual toner is removed by a belt cleaner 17 contacting the intermediate transfer belt 10.

A recording medium P having passed the second transfer nip leaves from the intermediate transfer belt 10 and is delivered to the conveyance belt unit. The conveyance belt unit hangs an endless conveyance belt 24 on two rollers (a drive roller and a driven roller) 23 and stretches the belt therebetween, and endlessly moves the belt anticlockwise with rotation of the drive roller. The recording medium P delivered from the second transfer nip is delivered to the fixer 25 with endless movement of the conveyance belt 24 while held on the stretched surface of the conveyance belt.

A recording medium fed from the paper feeder 43 or the manual feed tray 51 is fed to the surface processor 900. The recording medium P the surface of which is processed by the surface processor 900 is conveyed to the second transfer part 22 by pair of the registration rollers 49.

The developer is the same as that used in Embodiment 1. The toner had the same weight-average particle diameter (D4) as the toner in Embodiment 1. Further, the cleaner, the photoreceptor, and the undercoat layer included therein are the same as those in Embodiment 1.

Based on the above-described configuration, image quality of a practical example is compared with that of a comparative example and a comparison result is obtained through the following various experiments as listed below.

First, evaluation results shown in Table 2 are explained.

TABLE 2

| | | Surface | Surface | | |
|---|---|---|---|---|---|
| | Recording | Processing | Resistivity | Trans- | |
| | Medium | Conditions | (Ω) | ferability | Fixability |
| Example 7 | Recording | Recording | 1.2 × 10¹⁰ | Good | Good |
| | Medium A | Medium A | | | |
| Example 8 | Recording | Recording | 6.4 × 10¹⁰ | Good | Good |
| | Medium B | Medium B | | | |
| Example 9 | Recording | Recording | 1.0 × 10¹⁰ | Good | Good |
| | Medium C | Medium C | | | |
| Example 10 | Recording | Recording | 3.5 × 10¹¹ | Good | Good |
| | Medium D | Medium D | | | |
| Comparative | Recording | No | 1.0 × 10¹³ | Poor | Poor |
| Example 4 | Medium A | | or greater | | |
| Comparative | Recording | Recording | 3.1 × 10¹¹ | Fair | Poor |
| Example 5 | Medium A | Medium B | | | |
| Comparative | Recording | Recording | 1.7 × 10¹² | Poor | Fair |
| Example 6 | Medium A | Medium C | | | |
| Comparative | Recording | Recording | 2.5 × 10¹² | Poor | Good |
| Example 7 | Medium B | Medium C | | | |

TABLE 3

| | Recording Medium | | Surface Processing | |
|---|---|---|---|---|
| | Properties | | Conditions | |
| | Contact | Surface | Discharge | Feed Amount |
| | Angle (deg) | Resistivity (Ω) | Voltage (kV) | (g/min) |
| Recording | 110 | 1.0 × 10¹³ | 2.0 | 2.4 |
| Medium A | | or greater | | |
| Recording | 85 | 1.0 × 10¹³ | 1.6 | 2.0 |
| Medium B | | or greater | | |
| Recording | 115 | 1.5 × 10¹¹ | 2.0 | 1.2 |
| Medium C | | | | |
| Recording | 80 | 3.5 × 10¹¹ | 0.0 | 0.0 |
| Medium D | | | | |

### <Transferability>

Good: No uneven image density all over the surface
Fair: Slight uneven image density, but no problem in practical use
Poor: Uneven image density is apparently recognizable, and unusable

### <Fixability>

Good: No toner peeling
Fair: Slight toner peeling, but no problem in practical use
Poor: Toner peeling is apparently recognizable, and unusable

### Example 7

In FIG. 1, a discharge electrode 91 is formed of a stainless bar having a diameter of 10 mm and a length of 380 mm; a conductive ABS resin layer having a thickness of 1.2 mm overlying the bar; and a conductive acrylic silicone resin coating having a thickness about 100 μm overlying the ABS resin layer. A gap forming member having a thickness about 20 μm is layered near both ends of the discharge electrode. The discharge electrode is applied with a voltage through an unillustrated high-frequency (CT-0212 from Kasuga Electric Works Ltd.) and an unillustrated high-voltage transformer (CT-T02W from Kasuga Electric Works Ltd.). A line type binary fluid spray, a liquid supplier, a squeeze roller, a blower, a drive system and a control system which are separately prepared were installed therein to prepare a surface processor of recording media having the configuration in FIG. 1.

Polyethylene glycol as a toner affinity ingredient, dialkyl dimethyl ammonium salt as an antistatic agent ingredient, and a mixed solvent including ethanol and water were cast into the liquid supplier at a weight ratio of 10/0.5/89.5 to prepare a solution 1. A white polypropylene sheet (thickness 0.3 mm and A3 size) the both surfaces of which were processed was used as a recording medium. The conveyance speed of a recording medium was same as paper feeding speed of the image forming apparatus. The charger was applied with an alternating voltage. The voltage between peaks was changeable according to recording medium properties previously recorded in a memory of the image forming apparatus.

The conveyance belt of a recording medium was a medium resistivity belt and had a surface volume resistivity of 5.0×10¹⁰ Ω·cm, and was earthed through a metal roller on which the belt was hung on.

The solution including the toner affinity ingredient supplied to the binary fluid spray with compressed air from a compressor separately prepared, and was sprayed on the recording medium just after it passed the charger. The feed amount of the solution including the toner affinity ingredient was changeable according to recording medium properties previously recorded in a memory of the image forming apparatus. The surface of the recording medium the solution was applied to was scraped with a squeeze roller (reverse turns relative to travel direction of the recording medium) to remove the surplus solution and equalize the liquid adhering to the surface of the recording medium.

The recording medium passed a ventilation dryer and the surface-treated recording medium was supplied to the image forming apparatus.

Properties and setting conditions of recording media A to D were recorded in a memory of the image forming apparatus.

The recording medium A was placed in a manual feed unit of a modified on-demand printer RICOH Pro C901 from Ricoh Company, Ltd., and the setting conditions of the recording medium A were selected from a display of the printer to form a full-scale blue image on the recording medium A. An electrical resistance of the surface-treated recording medium measured by a high resistance resistometer Hirester HT-201 from Mitsubishi Petrochemical Co., Ltd. at a voltage 500V for 10 sec. was 1.2×10¹⁰Ω.

The uneven image density of the resultant images was visually evaluated and the fixability thereof was evaluated by a drawing tester AD-2110 from Ueshima Seisakusho Co., Ltd. The load of the drawing tester was 100 g, a movement stage was fixed, and the same point was rubbed 100 times to visually evaluate the toner peeling. The transferability and the fixability were both good. The surface processing conditions and the evaluation results are shown in Tables 2 and 3.

### Examples 8 to 10

The procedures for production of an image and evaluation thereof in Example 7 were repeated except for using the recording media B to D and selecting the surface processing conditions thereof, respectively. The surface processing conditions and the evaluation results are shown in Tables 2 and 3.

### Comparative Example 4

The procedures for production of an image and evaluation thereof in Example 7 were repeated except for selecting the surface processing conditions of the recording medium D, i.e., not processing the surface. The surface processing conditions and the evaluation results are shown in Tables 2 and 3.

### Comparative Examples 5 and 6>

The procedures for production of an image and evaluation thereof in Example 7 were repeated except for selecting the surface processing conditions of the recording media B and C, respectively. The surface processing conditions and the evaluation results are shown in Tables 2 and 3.

### Comparative Example 7

The procedures for production of an image and evaluation thereof in Example 7 were repeated except for using the recording media B and selecting the surface processing conditions of the recording medium C. The surface processing conditions and the evaluation results are shown in Tables 2 and 3.

Characteristics of the recording medium recorded in a memory may include an identification name or code, a surface resistivity and surface wettability thereof.

The recording medium may be selected from a display.

The surface processor may include a condition of not processing the surface.

The surface reformer may generate ozone. In addition, the surface reformer may have a discharge member or an exima lamp. Further, the surface reformer may have an ozone remover.

The applicator may have at least a liquid sprayer or a liquid applicator, and a leveler.

Having now fully described the invention, it will be apparent to one of ordinary skill in the art that many changes and modifications can be made thereto without departing from the spirit and scope of the invention as set forth therein.

What is claimed is:

1. A surface processor processing the surface of a recording medium before a toner image is formed thereon, comprising:
a surface reformer configured to reform the surface of the recording medium a toner image is formed on; and
an applicator configured to apply the surface of the recording medium after reformed with a toner affinity ingredient.

2. The surface processor of claim 1, wherein the surface reformer combines an ozone generator.

3. The surface processor of claim 1, wherein the surface reformer comprises a discharge member or an exima lamp.

4. The surface processor of claim 1, wherein the surface reformer comprises an ozone remover.

5. The surface processor of claim 1, wherein the applicator comprises a liquid sprayer or a liquid coater, and a leveler.

6. The surface processor of claim 1, wherein the toner affinity ingredient is applied in the form of at least one of a solution and a dispersion.

7. The surface processor of claim 1, wherein the recording medium has a lower surface electrical resistance after processed than before processed.

8. The surface processor of claim 1, wherein both surface sides of the recording medium are processed.

9. An electrophotographic image forming apparatus comprising the surface processor according to claim 1.

10. The electrophotographic image forming apparatus of claim 9, further comprising:
a memory configured to memorize properties of the recording medium;
a selector configured to select the recording medium; and
a setter configured to set processing conditions of the surface processor on the basis of the recording medium.
